(19) United States
(12) Patent Application Publication
(10) Pub. No.: US 2016/0316405 A1
(43) Pub. Date: Oct. 27, 2016

(54) DYNAMIC ADJUSTMENTS OF MEASUREMENT CONDITIONS ALONG WITH ADDITIONAL TRIGGER METHODS FOR REPORTING

(71) Applicant: NOKIA SOLUTIONS AND NETWORKS OY, Espoo (FI)

(72) Inventors: Irina-Mihaela BALAN, Munich (DE); Richard WALDHAUSER, Munich (DE); Hanns Jurgen SCHWARZBAUER, Groebenzell (DE)

(21) Appl. No.: 15/105,835

(22) PCT Filed: Jan. 30, 2014
(86) PCT No.: PCT/EP2014/051771

§ 371 Date: Jun. 20, 2016

(51) Int. Cl. H04W 36/00; H04W 24/10; H04W 36/30

(52) U.S. Cl. CPC H04W 36/0094; H04W 36/30; H04W 24/10; H04W 84/045

(57) ABSTRACT

The present invention provides apparatuses, methods, computer programs, computer program products and computer-readable media usable for triggering measurement reporting. The method includes configuring, at a base station, a measurement configuration message for triggering a start of measurement and reporting, the measurement configuration message comprising a dynamic threshold condition, and a first trigger for starting measurement and reporting, and transmitting said configured measurement configuration message to user equipment served by the base station.

### FIELD OF THE INVENTION

The present invention relates to apparatuses, methods, systems, computer programs, computer program products and computer-readable media regarding dynamic adjustments of measurement conditions along with additional trigger methods for reporting.

### BACKGROUND OF THE INVENTION

Due to the continuously growing traffic demand, mobile network operators (MNOs) are currently investigating ways of steering user traffic from the cellular network to the WLAN (wireless local area network) network in order to boost the coverage and capacity of their systems. As the end goal is improved end user experience, 3GPP (3^{rd} Generation Partnership Project) is also addressing the issue of cellular and WLAN interworking (cf. TR 37.834).

According to TR 37.834, in particular clause 6.1.3, it is proposed to let the RAN (radio access network) node configure WLAN related measurements in the UE (user equipment). However, but due to the fact that WLAN related measurements are not normalized and therefore not comparable between different UEs, this approach, according to decisions in 3GPP RAN plenary #62 is not to be further pursued for the time being.

Even in case this approach would have been selected, it would require the RAN node to request UEs to configure WLAN related measurements that are executed then as long as the UE is served by this RAN node.

However, this is additionally draining UE battery resources as the RAN node could not exert central control when to perform these measurements and the UE will perform these measurements starting from the point in time they have been configured.

In case a RAN node is aware of operator or partner WLANs in its coverage area, the RAN node is assumed to configure 3GPP RAN related measurements on the measurement item that is intended to be used in case of WLAN/3GPP radio interworking, e.g. RSRP (reference signal received power) measurement. In case the RAN node has no a priori information about deployment of operator or partner WLANs in its coverage area, the RAN node could only blindly attempt to configure measurements and request UEs to offload suitable traffic to WLAN.

To allow WLAN/3GPP radio interworking, the current assumption is that the UE is provided e.g. with an RSRP threshold for offload and an additional indication, later on referred to as WLAN Traffic Steering Indication (WTSI), when to attempt offloading traffic to WLAN. This additional indication could either be provided explicitly to the UE or derived implicitly by the UE based on other information received from the RAN node currently serving the UE. In examples that follow, for simplicity, only the explicit WTSI definition will be used.

For UEs in IDLE mode, this information could be provided only via System information Broadcast.

For UEs in CONNECTED mode, it is, however, possible for a RAN node to configure a UE measurement for RSRP with
a trigger having an appropriate threshold,
a large reporting interval, and
the reporting amount set to infinity.

Doing this without any other preconditions, the RAN node will receive these regular reports from all UEs served in this cell, but still lacks the knowledge whether this UE could be requested to attempt offloading traffic to WLAN as the report is not indicating the presence of suitable WLANs. Only having this additional information, the RAN node has adequate knowledge to correctly set e.g. the RSRP thresholds, for triggering actions of UEs in the coverage area of operator/partner WLANs.

Currently UEs continuously perform measurements (e.g. RSRP) and are configured to report when certain events are triggered. The measurements report contents and measurement report configuration are defined in TS 36.331.

Furthermore, the specification of the thresholds to be used in the measurements is static in the sense, that the measurement once configured with a specific threshold could not be modified “on the fly” but need to be removed and re-defined.

Moreover, the current measurement configuration does not allow enabling a preconfigured measurement in all UEs in a cell at the same time. Such enabling mechanism is useful in the case of 3GPP/WLAN offload because of the possible limited network knowledge of WLAN position and coverage.

FIG. 1 is a diagram illustrating an example of the current behaviour. In FIG. 1, the abscissa indicates time, the left ordinate indicates the RSRP measured by the UE and the right ordinate indicates the local WLAN quality rating of the UE. A dotted line in FIG. 1 indicates the RSRP over time measured by the UE (a degradation of RSRP may be due to UE mobility or changing radio conditions) and the short and long dash line in FIG. 1 indicates the WLAN quality rating of WLAN ID1 over time. The lower dashed line indicates a threshold of the minimum acceptable WLAN quality, which is based on a local UE decision, and the upper dashed line indicates the RSRP threshold from RAN measurement configuration.

In current specifications, a report is generated when the RSRP is below the defined threshold (e.g. event A2: serving cell becomes worse than the absolute threshold, cf. TS 36.331), which is indicated by a first vertical dotted line in FIG. 1. However, in the current specification, the presence of an acceptable WLAN, i.e. whose WLAN quality is above the threshold, is not taken into account.

### SUMMARY OF THE INVENTION

It is therefore an object of the present invention to overcome the above mentioned problems and to provide apparatuses, methods, systems, computer programs, computer program products and computer-readable media regarding dynamic adjustments of measurement conditions along with additional trigger methods for reporting.

According to an aspect of the present invention there is provided a method comprising:
configuring, at a base station, a measurement configuration message for triggering a start of measurement and reporting,
the measurement configuration message comprising a dynamic threshold condition, and a first trigger for starting measurement and reporting, and
transmitting said configured measurement configuration message to user equipment served by the base station.

According to another aspect of the present invention there is provided a method comprising:
receiving, at a user equipment, a measurement configuration message including a measurement condition, the measurement condition comprising a dynamic threshold condition, and a first trigger for starting measurement and reporting,
performing, by the user equipment, measurement on a serving cell in which the user equipment is located to obtain measurement results,
determining whether the measurement condition is fulfilled, and
   if it is determined that the measurement condition is fulfilled, transmitting a measurement report to a base station of the serving cell.

According to another aspect of the present invention there is provided an apparatus comprising:
at least one processor, and
at least one memory for storing instructions to be executed by the processor, wherein
the at least one memory and the instructions are configured to, with the at least one processor, cause the apparatus at least to perform a method according to any one of the above aspects.

According to another aspect of the present invention there is provided a computer program product comprising code means adapted to produce steps of any of the methods as described above when loaded into the memory of a computer.

According to a still further aspect of the invention there is provided a computer program product as defined above, wherein the computer program product comprises a computer-readable medium on which the software code portions are stored.

According to a still further aspect of the invention there is provided a computer program product as defined above, wherein the program is directly loadable into an internal memory of the processing device.

According to another aspect of the present invention there is provided an apparatus comprising:
means for configuring, at a base station, a measurement configuration message for triggering a start of measurement and reporting,
the measurement configuration message comprising a dynamic threshold condition and a first trigger for starting measurement and reporting, and
means for transmitting said configured measurement configuration message to user equipment served by the base station.

According to another aspect of the present invention there is provided an apparatus comprising:
means for receiving, at a user equipment, a measurement configuration message including a measurement condition, the measurement condition comprising a dynamic threshold condition, and a first trigger for starting measurement and reporting,
means for performing, by the user equipment, measurement on a serving cell in which the user equipment is located to obtain measurement results,
means for determining whether the measurement condition is fulfilled, and
means for transmitting a measurement report to a base station of the serving cell, if it is determined that the measurement condition is fulfilled.

Further aspects and features according to example versions of the present invention are set out in the appending claims.

### BRIEF DESCRIPTION OF THE DRAWINGS

These and other objects, features, details and advantages will become more fully apparent from the following detailed description of aspects/embodiments of the present invention which is to be taken in conjunction with the appended drawings, in which:

FIG. 1 is a diagram illustrating an example of a measurement in the prior art;

FIG. 2 is a diagram illustrating an example of a measurement based on RSRP threshold received from RAN assistance information and using explicit WTSI (first central trigger) and WLAN presence (second local trigger) as reporting triggers according to some example versions of the present invention; the third trigger (WLAN Discovery) is assumed to be set to FALSE.

FIG. 3 is a signaling diagram illustrating signaling between user equipment and a base station according to some example versions of the present invention;

FIG. 4 is a flowchart illustrating an example of a method according to example versions of the present invention;

FIG. 5 is a diagram illustrating an example of an apparatus according to example versions of the present invention;

FIG. 6 is a flowchart illustrating another example of a method according to example versions of the present invention;

FIG. 7 is a diagram illustrating another example of an apparatus according to example versions of the present invention.

### DETAILED DESCRIPTION

In the following, some example versions of the disclosure and embodiments of the present invention are described with reference to the drawings. For illustrating the present invention, the examples and embodiments will be described in connection with a cellular communication network based on a 3GPP based communication system, for example an LTE/LTE-A based system, and a wireless communication network such as, for example, WLAN. However, it is to be noted that the present invention is not limited to an application using such types of communication systems or communication networks, but is also applicable in other types of communication systems or communication networks and the like.

The following examples versions and embodiments are to be understood only as illustrative examples. Although the specification may refer to “an”, “one”, or “some” example version(s) or embodiment(s) in several locations, this does not necessarily mean that each such reference is to the same example version(s) or embodiment(s), or that the feature only applies to a single example version or embodiment. Single features of different embodiments may also be combined to provide other embodiments. Furthermore, words “comprising” and “including” should be understood as not limiting the described embodiments to consist of only those features that have been mentioned and such example versions and embodiments may also contain features, structures, units, modules etc. that have not been specifically mentioned.

The basic system architecture of a communication network where examples of embodiments of the invention are applicable may comprise a commonly known architecture of one or more communication systems comprising a wired or wireless access network subsystem and a core network. Such an architecture may comprise one or more communication network control elements, access network elements, radio access network elements, access service network gateways or base transceiver stations, such as a base station (BS), an access point or an eNB, which control a respective coverage area or cell and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities, operation and maintenance elements, and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a communication element or terminal device like a UE and a communication network control element like a radio network controller, besides those described in detail herein below.

The communication network is also able to communicate with other networks, such as a public switched telephone network or the Internet. The communication network may also be able to support the usage of cloud services. It should be appreciated that BSs and/or eNBs or their functionalities may be implemented by using any node, host, server or access node etc. entity suitable for such a usage.

Furthermore, the described network elements and communication devices, such as terminal devices or user devices like UEs, communication network control elements of a cell, like a BS or an eNB, access network elements like APs and the like, as well as corresponding functions as described herein may be implemented by software, e.g. by a computer program product for a computer, and/or by hardware. In any case, for executing their respective functions, correspondingly used devices, nodes or network elements may comprise several means, modules, units, components, etc. (not shown) which are required for control, processing and/or communication/signaling functionality. Such means, modules, units and components may comprise, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means comprising e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

Some example embodiments of the present invention relate to the above described measurements on RAN items, but using the independently sent indication by the RAN node to start offload related actions as a trigger (shown as WTSI=TRUE). Embodiments using the implicitly derived indication for offload actions are not shown as this would not provide additional insight.

It is noted that the RAN node is for example, a Node B (NB), or an evolved Node B (eNB), or the like.

By taking this first new (central) trigger, sent by the RAN node into account, the RAN node will only receive the appropriate measurement reports, if the served UEs have been requested to consider offloading traffic to WLAN and they have fulfilled the dynamic threshold conditions imposed by the RAN node. Even if these reports are sent by only those UEs meeting the dynamic threshold conditions, the RAN node still has no knowledge whether the reporting UE is in the coverage area of a suitable WLAN access point (AP), as there is no indication that the reporting UE is in the coverage area of one of the indicated operator/partner WLANs.

To overcome the lack of WLAN related information and reduce the number of reports, the RAN node, when configuring the measurement, needs to have the possibility to consider an additional local trigger in the UE for activating and sending the report. This local trigger would be responsible for the completion of the measurement report process if the UE is in the coverage area of one of the indicated operator/partner WLANs. Formally this could be described as an implicit second (local) trigger when configuring the measurement. The second local trigger depends on UE implementation and the RAN node has no knowledge or control over its setting.

As yet another enhancement, the measurement report could also include the identity of the WLAN(s) detected by the UE.

If these WLAN IDs are reported, the receiving RAN node may have additional degrees of freedom to inform the reporting UE to offload depending on the identity of the reported WLAN.

As yet another enhancement, a third (central) trigger (referred to as WLAN Discovery set as TRUE or FALSE) could be sent by the RAN node to determine all UEs in the cell coverage area to measure and report the RSRP and any visible WLAN being detected by WLAN scanning. The reporting would disregard any measurement threshold and will not cause UEs to offload to WLAN.

A combination of the WTSI and WLAN Discovery can be signaled to the UE and has the following impact as described in Table 1.

TABLE 1
Desired UE action upon reception of WTSI and WLAN Discovery

| | WLAN | |
|---|---|---|
| WTSI value | Discovery Value | UE action |
| TRUE | TRUE | All UEs will report available WLAN |
| | | IDs but only UEs that meet the |
| | | Offload condition will offload to |
| | | WLAN |
| | FALSE | Only UEs that meet the Offload |
| | | condition will offload to WLAN and |
| | | report availed WLAN IDs |
| FALSE | TRUE | All UEs will report available WLAN |
| | | IDs but no offload actions will be |
| | | taken |
| | FALSE | Do nothing |

According to some example embodiments of the present application, another significant improvement for the receiving RAN node is seen in the possible adjustment of the thresholds sent to the UEs. This is typically referred to as “Self Organizing Network” (SON) functionality.

Not having the feedback from UEs based on appropriate measurements, the RAN node could simply use “try and error” when adjustment of the thresholds is needed. Especially in case the RAN node is not aware of the WLAN AP locations, this is seen as major enhancement.

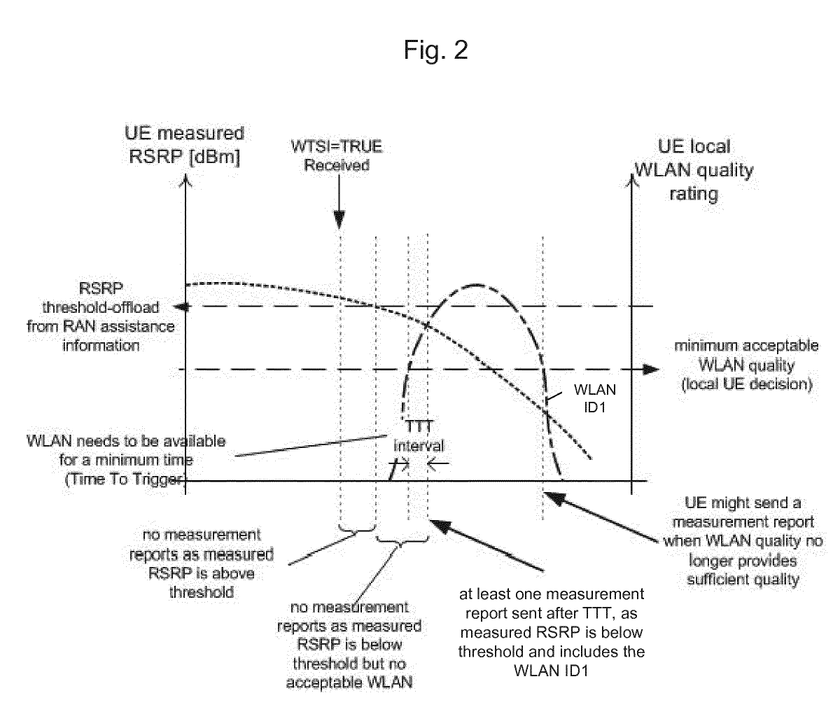

FIG. 2 is a diagram illustrating an example of a measurement using explicit WTSI WLAN presence as reporting triggers and assuming WLAN Discovery set to FALSE.

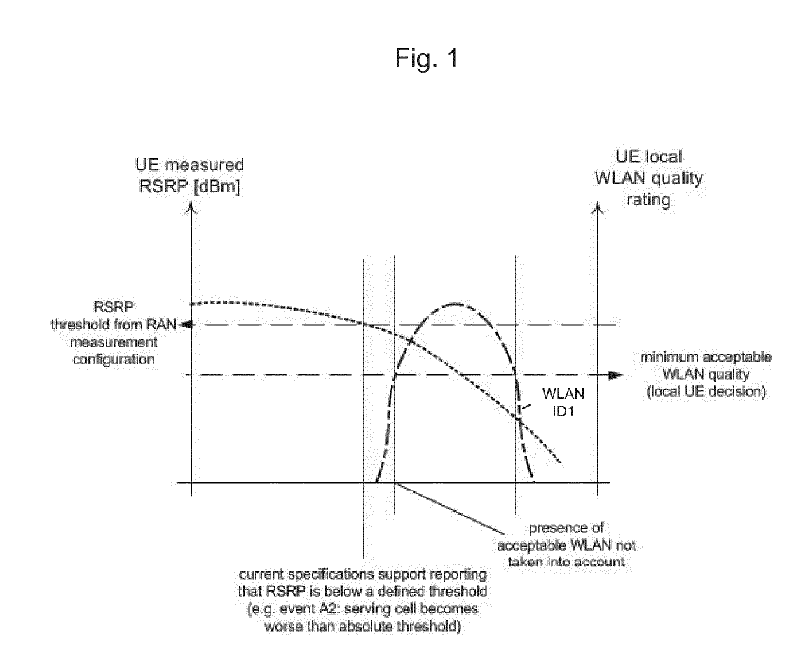

In a similar manner as described above in connection with FIG. 1, in FIG. 2, the abscissa indicates time, the left ordinate indicates the RSRP measured by the UE and the right ordinate indicates the local WLAN quality rating of the UE. A dotted line in FIG. 2 indicates the RSRP over time measured by the UE and the dotted and dashes line in FIG. 2 indicates the WLAN quality rating of WLAN id1 over time. The lower dashed line indicates a threshold of the minimum acceptable WLAN quality, which is based on a local UE decision, and the upper dashed line indicates the RSRP threshold from RAN assistance information.

At some instance in time, the UE receives or implicitly derives an indication WTSI=TRUE, which is indicated by the first vertical dotted line from the left in FIG. 2. The second vertical dotted line in FIG. 2 from the left indicates that the measured RSRP falls below the RSRP threshold. The third vertical dotted line from the left in FIG. 2 indicates the time when the WLAN quality exceeds the WLAN quality threshold, i.e. when the UE enters the WLAN coverage area. The fourth vertical dotted line from the left in FIG. 2 indicates the end of a time-to-trigger (TTT) interval. Further, the fifth vertical dotted line from the left in FIG. 2 indicates the time when the WLAN quality falls below the WLAN quality threshold, i.e. when the UE leaves the coverage area of the WLAN.

As long as the measured RSRP is above the RSRP threshold, no measurement reports are sent even when the WTSI is set to TRUE. If the measured RSRP falls below the RSRP threshold, no measurement report is sent until the TTT interval has elapsed. Then, when the TTT interval has elapsed, at least one measurement report is sent when the measured RSRP is still below the threshold. Such a measurement report may include the WLAN ID1. When the WLAN quality falls below the WLAN quality threshold, another measurement report may be sent by the UE.

The RAN node attempting WLAN offload will send the following information to targeted UEs.

Thresholds: The RAN sends the thresholds that are to be used by predefined Offload conditions and that are to be used for determining the network the UE should connect to.

Hence, an example of the Offload conditions could be as follows:

```
If “measurement_LTE”< “Threshold 1” AND “WLAN available”
            “Go to WLAN”
Else
            “Stay in LTE”
```

It is noted that the Offload conditions are of course not limited to the above example but that various other Offload conditions are conceivable. In the following example and figures, “measurement_LTE” refers to RSRP for simplicity. Other radio measurements may of course be used, e.g. RSRQ, user throughput, CQI, etc.

WTSI: This flag is set by the RAN node to TRUE in case offload of UEs to WLAN is desired and to FALSE in case onload to LTE from WLAN is required. In case no WTSI is transmitted, the UE will take no action.

This flag might be an explicit indication provided by the RAN node or implicitly derived by the UE dependent on, but not limited to, the presence or absence of other offload related information sent by RAN node. An explicit indication is assumed in the following example for simplicity reasons.

WLAN Discovery: This flag is set by the RAN node to TRUE in case reports from all UE on available WLAN IDs are desired but offload is not desired. A setting to FALSE has no impact on the UE.

WLAN ID: The RAN node may also transmit a list of WLAN IDs that are preferred by the operator for offload. The WLAN IDs may also have priorities (highest priority to operator deployed WLAN, seconds highest to partner WLAN, etc).

It is noted that these information elements can be transmitted in one message or in separate massages depending on the situation. According to some example versions of the present invention, the thresholds may be set to fixed values and only the WTSI changes depending on cell load. According to some further example versions of the present invention, the WTSI may remain the same for a long time and the RAN node decides to make adjustments in the thresholds values.

In addition to the definitions provided in TS 36.331, according to some example versions of the present invention, there is defined a new event A7 that has as a trigger the receipt of the WTSI set to TRUE from the serving RAN node.

Further details in this regard are illustrated in the ASN1 (Abstract Syntax Notation 1) code below, which defines the ReportConfigEUTRA information element and is based on section 6.3.5 of document TS 36.331.

In the following ASN1 (Abstract Syntax Notation 1) code example, the text written in italic font indicates existing elements that are used by the newly defined event A7 and the underlined text in bold indicates additions regarding the state of the art.

The flag a7-ReportWlanIdList-r12 indicates whether the measurement report needs to include the list of available WLAN IDs detected.

| | |
|---|---|
| -- ASN1START | |
| ReportConfigEUTRA ::= | SEQUENCE { |

| | |
|---|---|
| triggerType | CHOICE { |
| event | SEQUENCE { |
| eventId | CHOICE { |
| eventA1 | SEQUENCE { |
| a1-Threshold | ThresholdEUTRA |
| }, | |
| eventA2 | SEQUENCE { |
| a2-Threshold | ThresholdEUTRA |
| }, | |
| eventA3 | SEQUENCE { |
| a3-Offset | INTEGER (−30..30), |
| reportOnLeave | BOOLEAN |
| }, | |
| eventA4 | SEQUENCE { |
| a4-Threshold | ThresholdEUTRA |
| }, | |
| eventA5 | SEQUENCE { |
| a5-Threshold1 | ThresholdEUTRA, |
| a5-Threshold2 | ThresholdEUTRA |
| }, | |
| ..., | |
| eventA6-r10 | SEQUENCE { |
| a6-Offset-r10 | INTEGER (−30..30), |
| a6-ReportOnLeave-r10 | BOOLEAN |
| } | |
| eventA7-r12 | SEQUENCE ( |
| a7-threshold-r12 | INTEGER (taken from the RAN assistance |
| | information), |
| a7-WTSI-r12 | BOOLEAN |
| a7-WLANDiscovery-r12 | BOOLEAN |

a7-ReportWlanIdList-r12 BOOLEAN

| | |
|---|---|
| } | |
| }, | |
| hysteresis | Hysteresis, |
| timeToTrigger | TimeToTrigger |
| }, | |
| periodical | SEQUENCE { |
| purpose | ENUMERATED { |
| | reportStrongestCells, reportCGI} |
| } | |
| }, | |
| triggerQuantity | ENUMERATED {rsrp, rsrq}, |
| reportQuantity | ENUMERATED {sameAsTriggerQuantity, both}, |
| maxReportCells | INTEGER (1..maxCellReport), |
| reportInterval | ReportInterval, |
| reportAmount | ENUMERATED {r1, r2, r4, r8, r16, r32, r64, infinity}, |
| ..., | |

| | | | |
|---|---|---|---|
| [[ si-RequestForHO-r9 | ENUMERATED {setup} | OPTIONAL, | -- Cond |
| reportCGI | | | |
| ue-RxTxTimeDiffPeriodical-r9 | ENUMERATED {setup} | OPTIONAL | -- Need OR |
| ]], | | | |
| [[ includeLocationInfo-r10 | ENUMERATED {true} | OPTIONAL, | -- Need OR |
| reportAddNeighMeas-r10 | ENUMERATED {setup} | OPTIONAL | -- Need OR |
| ]] | | | |
| } | | | |

| | |
|---|---|
| ThresholdEUTRA ::= | CHOICE{ |
| threshold-RSRP | RSRP-Range, |
| threshold-RSRQ | RSRQ-Range |
| } | |
| -- ASN1STOP | |

Further, in the following, the ASN1 (Abstract Syntax Notation 1) code defining the MeasResults information element based on section 6.3.5 of document TS 36.331 is shown.

In the following code, the text written in italic font indicates existing elements that are used by the newly defined event A7 and the underlined text indicates additions regarding the state of the art.

The ASN1 code below presents two different options on how to construct the measurement report shown in bold underlined and in bold underlined italic.

| | |
|---|---|
| MeasResults ::= | SEQUENCE { |

| | |
|---|---|
| measId | MeasId, |

| | |
|---|---|
| MeasResultPCell | SEQUENCE { |

| | |
|---|---|
| rsrpResult | RSRP-Range, |
| rsrqResult | RSRQ-Range |

| }, | |
|---|---|
| measResultNeighCells | CHOICE { |

| | |
|---|---|
| measResultListEUTRA | MeasResultListEUTRA, |
| measResultListUTRA | MeasResultListUTRA, |
| measResultListGERAN | MeasResultListGERAN, |
| measResultsCDMA2000 | MeasResultsCDMA2000, |

| ... | |
|---|---|
| measResultsWLAN | MeasResultsWLAN, |

| | |
|---|---|
| } | OPTIONAL, |
| ..., | |

| [[ | measResultForECID-r9 | MeasResultForECID-r9 | OPTIONAL |
|---|---|---|---|
| ]], | | | |
| [[ | locationInfo-r10 | LocationInfo-r10 | OPTIONAL, |

| | | |
|---|---|---|
| measResultServFreqList-r10 | MeasResultServFreqList-r10 | OPTIONAL |

| ]] | | |
|---|---|---|
| [symbol] | [symbol] | [symbol] |

]]

}
MeasResultsWLAN ::= SEQUENCE OF ID-WLAN-r12
ID-WLAN-r12 ::= OCTET STRING (SIZE (4))

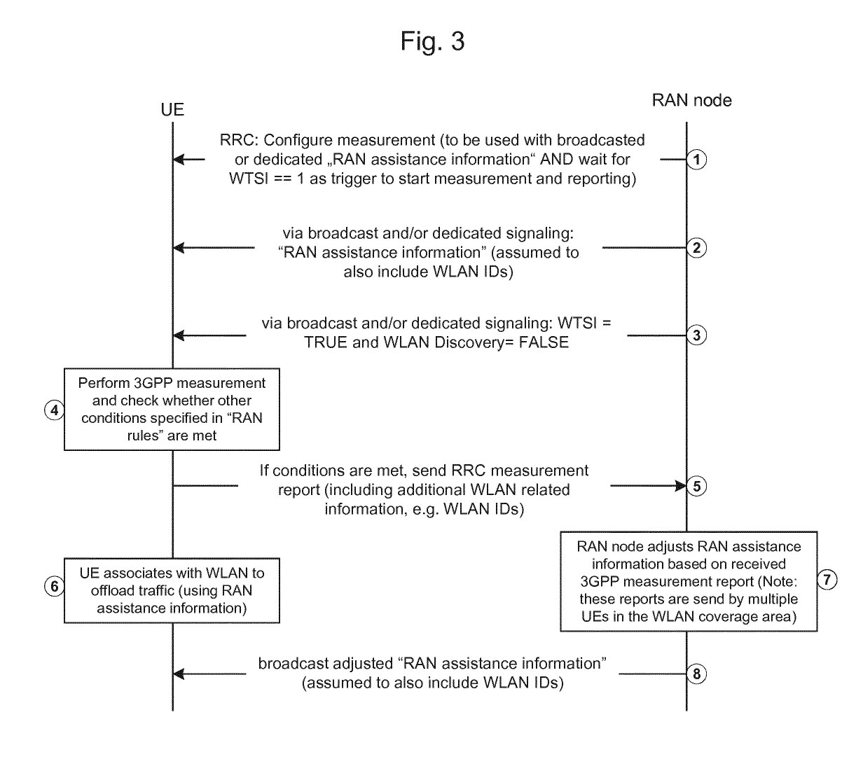

FIG. 3 is a signaling diagram illustrating the signaling between the UE and a RAN node, like e.g. a NB or eNB, regarding the measurement configuration according to some example versions of the present invention.

In step 1 in FIG. 3, the RAN node sends a measurement configuration message (ReportConfigEUTRA) to all served UEs. This configures an event A7 that has as an entering condition the detection of the WTSI set to TRUE. That is, the RAN node configures the measurement which will use broadcasted or dedicated RAN assistance information, to be provided at a later point in time. Therefore, an initial value for “a7-threshold-r12” in the definition of “eventA7-R12” in the ASN1 code example shown before is set to “0” with the meaning of “shall be ignored” for the time being by the UE.

It is noted that step 1 is shown as being performed only once, when the UE first attaches to the cell or is handed over from a neighbouring cell. This approach has the advantage that measurement reporting is always configured but activated by the RAN node only when needed (i.e. WTSI set to TRUE). Details on how this might be implemented are derivable from the underlined passage in the ASN1 code of the ReportConfigEUTRA information element.

In step 2, the RAN node sends RAN assistance information to the served UEs consisting of thresholds and possibly WLAN IDs. This can be done via broadcast or via dedicated messaging. The value of the included threshold used for offloading is to be used as “a7-threshold-r12” by the UE in the definition of “eventA7-R12” in the ASN1 code example shown before.

In step 3, at some point in time, the RAN node sets the WTSI to TRUE and sends this to all or some of the served UEs. The WTSI might be set to TRUE due to a high load situation. The same may contain the WLAN Discovery setting, in this example, it is assumed to be FALSE.

It should be noted that steps 2 and 3 could be combined in one single message without loss of generality. In this embodiment the UE could implicitly derive the WTSI based on the received “RAN assistance information”.

Then, in step 4, the UE that has received or implicitly determined the WTSI set to TRUE and the RAN assistance information and has been configured with event A7, will start performing measurements. Other UEs that have not received or determined the WTSI set to TRUE or did not receive the RAN assistance information at all will not perform measurements and check whether the Offload conditions are met.

If a UE determines in step 4 that the Offload conditions are fulfilled (using the thresholds provided by RAN), it will generate a measurement report containing the measured RSRP and the ID(s) of the WLAN(s) it has detected (i.e. measResultForAvailabeWLANs-r12 in the ASN1 code of the MeasResults information element). This measurement report is then sent to the serving RAN node in step 5. UEs that have not been triggered in the previous step to perform measurements will not generate any reports. Details on how this might be implemented are derivable from the underlined passages in the ASN1 code of the MeasResults information element.

Depending on the timing of the detection of the WLANs on the UE side, multiple reports could be generated and sent by the UE. This, however, requires appropriate measurement configuration to allow multiple reports to be sent.

In step 6, the UEs that have generated and sent reports in step 5 might now associate with the reported WLAN in order to offload traffic thereto. If multiple WLANs are available, the UE will associate with the one providing the best quality, lowest load or highest priority, depending on configured UE policy.

In step 7, the measurement reports generated by event A7 will be collected at the RAN node. The RAN node may then decide to adjust the RAN thresholds (i.e. a7-threshold-r12 in the ASN1 code of the ReportConfigEUTRA information element described above) provided to the UE depending on how successful the offloading was in this step. That is, if load situation was not improved, the RAN node may lower the thresholds in an attempt to let more UEs qualify for offload. The RAN node may also decide to configure the event A7 on a different number of UEs, if necessary.

Although UEs in idle will not generate any event A7 reports, their network selection process will also be influenced by the threshold modifications in the broadcast.

In step 8, which is similar to step 2, the RAN node sends RAN assistance information consisting of thresholds and possibly WLAN IDs to the served UEs. This can be done via broadcast or via dedicated messaging. In this step 8, the RAN node might send adjusted RAN assistance information and this adjusted information is used to dynamically adapt the measurements performed in step 4 only.

In the above description, the interaction between the UE and the RAN node according to some example version of the present invention has been described with respect to FIG. 3.

In the following, the operations of the UE and the RAN node according to some example version of the present invention will be separately described.

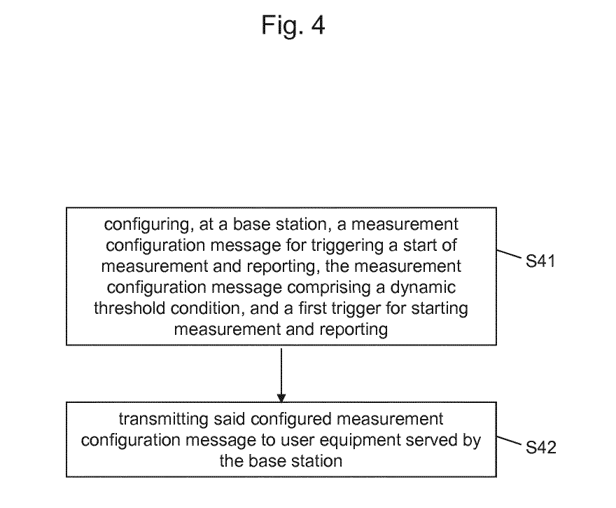

In the foregoing, some example versions of the present invention have been described in detail with respect to a 3GPP mobile network and a wireless local area network. In the following, a more general description of certain embodiments of the present invention is made with respect to FIGS. 4 to 7.

FIG. 4 is a flowchart illustrating an example of a method according to example versions of the present invention.

According to example versions of the present invention, the method may be implemented in a RAN node, like e.g. a base station, NB or eNB, or the like. In step S41, the method comprises configuring, at a base station, a measurement configuration message for triggering a start of measurement and reporting, the measurement configuration message comprising a dynamic threshold condition, and a first trigger for starting measurement and reporting, and transmitting the configured measurement conditions to user equipment served by the base station in a step S42.

According to example versions of the present invention, the method further comprises transmitting a message indicating a current value of the first trigger.

According to example versions of the present invention, the method further comprises receiving, at the base station, a measurement report from the user equipment, and adjusting the threshold value of the dynamic threshold condition based on the received measurement report, and transmitting the adjusted threshold value to the user equipment served by the base station.

According to example versions of the present invention, the first trigger is a central trigger and indicates whether the user equipment that receives the configured measurement configuration message is requested to consider offloading traffic to a local wireless communication network.

According to example versions of the present invention, the measurement configuration message comprises a third trigger for starting measurement and reporting, wherein the third trigger is a central trigger and indicates whether the user equipment starts measurement and reporting irrespective of the dynamic threshold condition.

According to example versions of the present invention, the method further comprises transmitting a message indicating a current value of the third trigger.

According to example versions of the present invention, the message including the threshold value and/or the message including the adjusted threshold value and/or any of the messages indicating the current value of the first or third trigger is transmitted via broadcast and/or dedicated signaling to the user equipment served by the base station.

According to example versions of the present invention, the message including the threshold value and/or the message including the adjusted threshold value and/or the measurement report includes information on an identification of the local wireless communication network

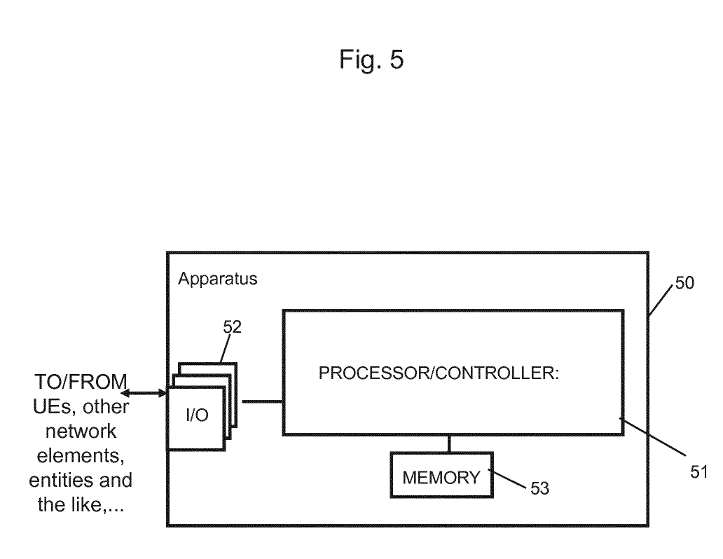

FIG. 5 is a block diagram showing an example of an apparatus according to example versions of the present invention. According to example versions of the present invention, the apparatus may be implemented in or may be part of a RAN node, like e.g. a base station, NB or an eNB or the like.

In FIG. 5, a block circuit diagram illustrating a configuration of an apparatus 50 is shown, which is configured to implement the above described aspects of the invention. It is to be noted that the apparatus 50 shown in FIG. 5 may comprise several further elements or functions besides those described herein below, which are omitted herein for the sake of simplicity as they are not essential for understanding the invention. Furthermore, the apparatus may be also another device having a similar function, such as a chipset, a chip, a module etc., which can also be part of an apparatus or attached as a separate element to the apparatus, or the like.

The apparatus 50 may comprise a processing function or processor 51, such as a CPU or the like, which executes instructions given by programs or the like related to the flow control mechanism. The processor 51 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 52 denotes transceiver or input/output (I/O) units (interfaces) connected to the processor 51. The I/O units 52 may be used for communicating with one or more other network elements, entities, user equipments, terminals or the like. The I/O units 52 may be a combined unit comprising communication equipment towards several network elements, or may comprise a distributed structure with a plurality of different interfaces for different network elements. Reference sign 53 denotes a memory usable, for example, for storing data and programs to be executed by the processor 51 and/or as a working storage of the processor 51.

The processor 51 is configured to execute processing related to the above described aspects. In particular, as described above, the apparatus 50 may be implemented in or may be part of a RAN node, like e.g. a base station, NB or an eNB or the like, and may be configured to perform a method as described in connection with FIG. 4. Thus, the processor 51 is configured to perform configuring, at a base station, a measurement condition triggering start of measurement and reporting, the measurement condition including a first trigger and a second trigger for starting measurement and reporting, and transmitting the configured measurement conditions to user equipment served by the base station.

For further details in this regard, reference is made to the description of the method in connection with FIG. 4.

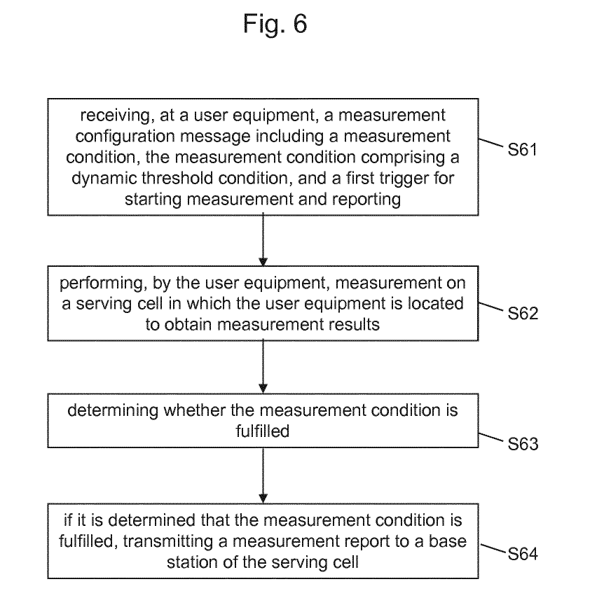

FIG. 6 is a flowchart illustrating another example of a method according to example versions of the present invention.

According to example versions of the present invention, the method may be implemented in a user equipment UE or the like, and comprises receiving, at a user equipment, a measurement configuration message including a measurement condition in a step S61, the measurement condition comprising a dynamic threshold condition and a first trigger for starting measurement and reporting. Further, the method comprises performing, in a step S62, measurement on a serving cell in which the user equipment is located to obtain measurement results, determining, based on the measurement results, whether the measurement condition is fulfilled in a step S63, and if it is determined that the measurement condition is fulfilled, transmitting the measurement result to a base station of the serving cell in a step S64.

According to example versions of the present invention, the method further comprises receiving, at the user equipment, a message including a threshold value of the dynamic threshold condition from the base station.

According to example versions of the present invention, the method further comprises receiving a message indicating the current value of the first trigger.

According to example versions of the present invention, the method further comprises deriving the current value of the first trigger from the message including a threshold value of the dynamic threshold condition.

According to example versions of the present invention, the measurement condition is determined to be fulfilled, if it is determined that the measurement result fulfils the dynamic threshold condition, and the first trigger is set to TRUE.

According to example versions of the present invention, the method further comprises, if it is determined that the measurement condition is fulfilled, offloading, by the user equipment, of traffic to a local wireless communication network.

According to example versions of the present invention, the measurement condition comprises a third trigger, and the method further comprises receiving a message indicating the current value of the third trigger.

According to example versions of the present invention, the method further comprises, if it is determined that the third trigger is set to TRUE, transmitting a measurement report to a base station of the serving cell irrespective of the value of the first trigger and the dynamic threshold condition.

According to example versions of the present invention, the measurement on the serving cell includes radio related measurements as configured by the base station.

According to example versions of the present invention, the first trigger is a central trigger and indicates whether the user equipment that receives the configured measurement configuration message is requested to consider offloading traffic to a local wireless communication network.

According to example versions of the present invention, the method further comprises a second trigger which is a local trigger and indicates that the user equipment starts measurement and reporting when the user equipment is located within the coverage area of a local wireless communication network.

According to example versions of the present invention, the third trigger is a central trigger and indicates whether the user equipment starts measurement and reporting irrespective of the dynamic threshold condition and the value of the first trigger.

According to example versions of the present invention, the message including the threshold value and/or any of the messages indicating the current value of the first, or third trigger is transmitted via broadcast and/or dedicated signaling to the user equipment served by the base station.

According to example versions of the present invention, the message including the threshold value and/or the measurement report includes information on an identification of the local wireless communication network.

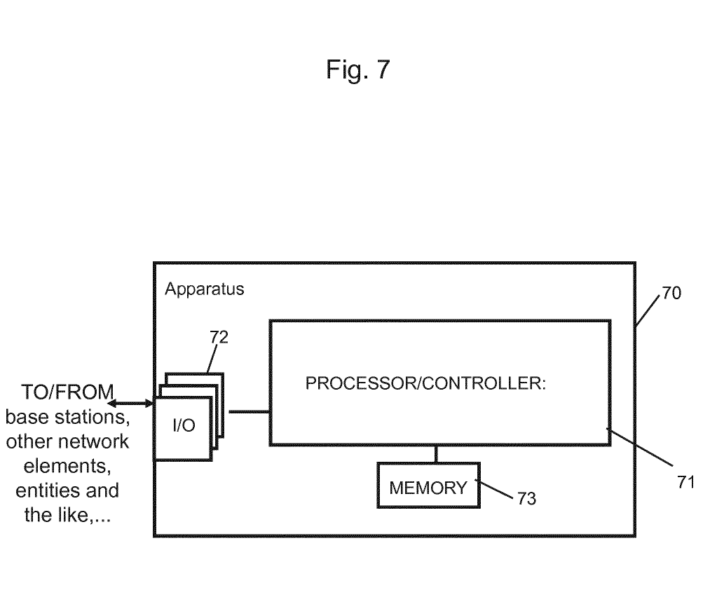

FIG. 7 is a block diagram showing another example of an apparatus according to example versions of the present invention. According to example versions of the present invention, the apparatus may be implemented in or may be part of a user equipment (UE) or the like.

In FIG. 7, a block circuit diagram illustrating a configuration of an apparatus 70 is shown, which is configured to implement the above described aspects of the invention. It is to be noted that the apparatus 70 shown in FIG. 7 may comprise several further elements or functions besides those described herein below, which are omitted herein for the sake of simplicity as they are not essential for understanding the invention. Furthermore, the apparatus may be also another device having a similar function, such as a chipset, a chip, a module etc., which can also be part of an apparatus or attached as a separate element to the apparatus, or the like.

The apparatus 70 may comprise a processing function or processor 71, such as a CPU or the like, which executes instructions given by programs or the like related to the flow control mechanism. The processor 71 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 72 denotes transceiver or input/output (I/O) units (interfaces) connected to the processor 71. The I/O units 72 may be used for communicating with one or more other network elements, entities, user equipments, terminals or the like. The I/O units 72 may be a combined unit comprising communication equipment towards several network elements, or may comprise a distributed structure with a plurality of different interfaces for different network elements. Reference sign 73 denotes a memory usable, for example, for storing data and programs to be executed by the processor 71 and/or as a working storage of the processor 71.

The processor 71 is configured to execute processing related to the above described aspects. In particular, the apparatus 70 may be implemented in or may be part of a user equipment (UE) or the like, and may be configured to perform a method as described in connection with FIG. 6. Thus, the processor 71 is configured to perform receiving, at a user equipment, a measurement condition, the measurement condition including a first trigger and a second trigger for starting measurement and reporting, performing, by the user equipment, measurement on a serving cell in which the user equipment is located to obtain measurement results, determining, based on the measurement results, whether the measurement condition is fulfilled, and if it is determined that the measurement condition is fulfilled, transmitting the measurement result to a base station of the serving cell.

For further details in this regard, reference is made to the description of the method in connection with FIG. 6.

The advantage according to some example versions of the present invention is that it enables reporting from a large number of UEs at the same time. Such a mechanism is useful in the case of 3GPP/WLAN offload due to the possibly limited network knowledge of WLAN position and coverage. Furthermore it enables new functions for the SON functionality.

According to some example versions of the present invention, yet another enhancement to the measurement process shown above is to allow taking modified thresholds signaled by RAN (broadcast or dedicated) into account, without the need to re-configure the actual measurement.

According to some example versions of the present invention, yet another enhancement to the measurement process is to allow the UE to also report modifications in the list of available WLAN IDs, e.g. WLANs that become available after a first report was sent or a previously reported WLAN is no longer available.

In the foregoing exemplary description of the apparatuses, only the units/means that are relevant for understanding the principles of the invention have been described using functional blocks. The apparatus may comprise further units/means that are necessary for its respective operation as base station or user equipment, and the like, respectively. However, a description of these units/means is omitted in this specification. The arrangement of the functional blocks of the apparatus is not construed to limit the invention, and the functions may be performed by one block or further split into sub-blocks.

When in the foregoing description it is stated that the apparatus (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

For the purpose of the present invention as described herein above, it should be noted that
method steps likely to be implemented as software code portions and being run using a processor at an apparatus (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the aspects/embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the aspects/embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective units/means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

It is noted that the aspects/embodiments and general and specific examples described above are provided for illustrative purposes only and are in no way intended that the present invention is restricted thereto. Rather, it is the intention that all variations and modifications which fall within the scope of the appended claims are covered.

1. A method, comprising:
configuring, at a base station, a measurement configuration message for triggering a start of measurement and reporting,
the measurement configuration message comprising a dynamic threshold condition, and a first trigger for starting measurement and reporting, and
transmitting the configured measurement configuration message to user equipment served by the base station.

2. The method according to claim 1, further comprising:
transmitting, by the base station, a message including the threshold value of the dynamic threshold condition to the user equipment.

3. The method according to claim 1, further comprising at least one of the following:
transmitting a message indicating a current value of the first trigger,
wherein the first trigger is a central trigger and indicates whether the user equipment that receives the configured measurement configuration message is requested to consider offloading traffic to a local wireless communication network,
wherein the measurement configuration message comprises a third trigger for starting measurement and reporting, and wherein the third trigger is a central trigger and indicates whether the user equipment starts measurement and reporting irrespective of the dynamic threshold condition, and the method further comprising transmitting a message indicating a current value of the third trigger.

4. The method according to claim 1, further comprising:
receiving, at the base station, a measurement report from the user equipment,
adjusting the threshold value of the dynamic threshold condition based on the received measurement report, and
transmitting the adjusted threshold value to the user equipment served by the base station.

5-7. (canceled)

8. The method according to claim 1, further comprising at least one of the following:
the message including the threshold value and/or the message including the adjusted threshold value and/or any of the messages indicating the current value of the first, or third trigger is transmitted via broadcast and/or dedicated signaling to the user equipment served by the base station, and
wherein the message including the threshold value and/or the message including the adjusted threshold value and/or the measurement report includes information on an identification of the local wireless communication network.

9. The method according to claim 1, wherein
the message including the threshold value and/or the message including the adjusted threshold value and/or the measurement report includes information on an identification of the local wireless communication network.

10. A method, comprising:
receiving, at a user equipment, a measurement configuration message including a measurement condition, the measurement condition comprising a dynamic threshold condition, and a first trigger for starting measurement and reporting,
performing, by the user equipment, measurement on a serving cell in which the user equipment is located to obtain measurement results,
determining whether the measurement condition is fulfilled, and
if it is determined that the measurement condition is fulfilled, transmitting a measurement report to a base station of the serving cell.

11. The method according to claim 10, further comprising:
receiving, at the user equipment, a message including a threshold value of the dynamic threshold condition from the base station.

12. The method according to claim 10, further comprising:
receiving a message indicating the current value of the first trigger.

13. The method according to claim 10, further comprising:
deriving the current value of the first trigger from the message including a threshold value of the dynamic threshold condition.

14. The method according to claim 10, wherein
the measurement condition is determined to be fulfilled, if it is determined that the measurement result fulfils the dynamic threshold condition, and the first trigger is set to TRUE.

15. The method according to claim 14, further comprising:
if it is determined that the measurement condition is fulfilled,
offloading, by the user equipment, of traffic to a local wireless communication network.

16. The method according to claim 10, wherein
the measurement condition comprises a third trigger, further comprising receiving a message indicating the current value of the third trigger.

17. The method according to claim 16, further comprising:
if it is determined that the third trigger is set to TRUE, transmitting a measurement report to a base station of the serving cell irrespective of the value of the first trigger and the dynamic threshold condition.

18. The method according to claim 10, wherein
the measurement on the serving cell includes radio related measurements as configured by the base station.

19. The method according to claim 10, wherein the first trigger is a central trigger and indicates whether the user equipment that receives the configured measurement configuration message is requested to consider offloading traffic to a local wireless communication network.

20. The method according to claim 16, further comprising:
a second trigger which is a local trigger and indicates that the user equipment starts measurement and reporting when the user equipment is located within the coverage area of a local wireless communication network, and
wherein the third trigger is a central trigger and indicates whether the user equipment starts measurement and reporting irrespective of the dynamic threshold condition and the value of the first trigger.

21. (canceled)

22. The method according to claim 10, and further comprising at least one of the following:
the message including the threshold value and/or any of the messages indicating the current value of the first, or third trigger is transmitted via broadcast and/or dedicated signaling to the user equipment served by the base station, and
the message including the threshold value and/or the measurement report includes information on an identification of the local wireless communication network.

23. (canceled)

24. An apparatus, comprising:
at least one processor, and
at least one memory for storing instructions to be executed by the processor, wherein the at least one memory and the instructions are configured to, with the at least one processor, cause the apparatus at least to perform a method according to claim 1.

25. An apparatus, comprising:
at least one processor, and
at least one memory for storing instructions to be executed by the processor, wherein the at least one memory and the instructions are configured to, with the at least one processor, cause the apparatus at least to perform a method according to claim 10.

26. A computer program product including a non-transitory computer-readable medium and storing a program comprising software code portions being arranged, when run on the processing device, to perform the method according to claim 1, wherein the program is directly loadable into an internal memory of the processing device.

27-30. (canceled)
